(19) United States
(12) Patent Application Publication
(10) Pub. No.: US 2026/0293903 A1
(43) Pub. Date: Oct. 1, 2026

(54) CHLORINE BASED DISINFECTANT AND METHODS OF PREPARATION THEREOF

(71) Applicant: Stephen Newman, Weatherford, TX (US)

(72) Inventor: Stephen Newman, Weatherford, TX (US)

(21) Appl. No.: 19/097,853

(22) Filed: Apr. 1, 2025

(51) Int. Cl. A01N 59/00; A01N 25/14; A01P 1/00

(52) U.S. Cl. CPC A01N 59/00; A01N 25/14; A01P 1/00

(57) ABSTRACT

Chlorine based disinfectants and methods of preparation of the same are described, and more particularly to a composition that may be mixed with water to form the chlorine based disinfectant, and its associated methods of preparation. In one aspect, a composition comprises 15%-50% by a weight of a Calcium Hypochlorite (Ca(OCl)₂), 15%-50% by the weight of a Sodium Bisulfate (NaHSO₄), and 15%-50% by the weight of an Adipic Acid (C₆H₁₀O₄). The composition may include wherein each of the Calcium Hypochlorite, the Sodium Bisulfate, and/or the Adipic Acid are in powder form. The composition may include wherein the composition is packaged in at least one of an HDPE container and/or a PET container. The composition may include wherein the composition is dissolved in a water to form a buffered solution that may maintain a pH of 3.5-7. The composition may include wherein a FAC concentration in the buffered solution may be between 50-1200 ppm.

### FIELD OF TECHNOLOGY

This disclosure relates generally to the field of chlorine based disinfectants and methods of preparation of the same, and more particularly to a powdered composition that may be mixed with water to form the chlorine based disinfectant, and its associated methods of preparation.

### BACKGROUND

Disinfectants and/or sanitizing solutions may be used across medical, agricultural, food processing, and/or consumer applications to eliminate harmful pathogens, but these solutions suffer from significant drawbacks that limit their effectiveness, shelf stability, and/or ease of use.

Disinfectants and/or sanitizing solutions may have poor stability over time. Disinfectants and/or sanitizing solutions may be prone to rapid degradation, particularly when exposed to air, light, and/or fluctuations in temperature. Disinfectants and/or sanitizing solutions may lose efficacy within weeks or months. Furthermore, disinfectants and/or sanitizing solutions may require frequent replenishment and/or careful storage conditions. This instability may lead to inconsistent disinfecting power which may increase the risk of inadequate pathogen control.

Disinfectants and/or sanitizing solutions may release toxic chemicals and/or fumes, which may accumulate in treated environments, which may result in residual toxicity, skin irritation, and/or unintended chemical byproducts.

Free available chlorine (“FAC”) based solutions may exhibit high variability in active chlorine release, which may lead to inconsistent microbial efficacy. Additionally, some FAC products may produce dangerous chlorinated byproducts when exposed to organic matter, raising environmental and health concerns. FAC-based solutions may have short-lived effectiveness once mixed with water. HOCl and/or FAC-based solutions may experience pH drift over time, which may reduce their ability to maintain an optimal chlorine species balance.

The shipping and storage of Disinfectants and/or sanitizing solutions may also present logistical challenges. Disinfectants and/or sanitizing solutions may be bulky, heavy, and/or require specialized containers to prevent gas leakage and/or chemical degradation. These products may increase transportation costs and/or complicate large-scale distribution, particularly in resource-limited settings.

Furthermore, existing disinfectants and/or sanitizing solutions may fail to provide a flexible range of use cases. Solutions designed for agricultural applications may lack the necessary potency for medical sterilization, while hospital-grade disinfectants may be too harsh for food-contact surfaces and/or personal hygiene applications. This lack of adaptability may force users to purchase multiple products for different purposes, which may lead to higher costs and/or greater storage requirements.

### SUMMARY

Chlorine based disinfectants and methods of preparation of the same are described, and more particularly to a powdered composition that may be mixed with water to form the chlorine based disinfectant, and its associated methods of preparation.

In one aspect, a composition comprises 15%-50% by a weight of a Calcium Hypochlorite (Ca(OCl)₂), 15%-50% by the weight of a Sodium Bisulfate (NaHSO₄), and 15%-50% by the weight of an Adipic Acid (C₆H₁₀O₄). The composition may include wherein each of the Calcium Hypochlorite, the Sodium Bisulfate, and/or the Adipic Acid are in powder form. The composition may include wherein the composition is packaged in at least one of an HDPE container and/or a PET container. The composition may include wherein the composition is dissolved in a water to form a buffered solution that may maintain a pH of 3.5-7. The composition may include wherein a FAC concentration in the buffered solution may be between 50-1200 ppm. The composition may include wherein the FAC concentration in the buffered solution may be between 500-1000 ppm and/or the buffered solution may comprise a pH of 5-7. The composition may include wherein the FAC concentration in the buffered solution is between 50-200 ppm and/or the buffered solution may comprise a pH of 5-7.

The composition may include wherein the buffered solution is stored in the HDPE container. The composition may include wherein the buffered solution is stored in the PET container. The composition may include wherein the weight of the Calcium Hypochlorite is 1.5 g to 6.0 g, the weight of the Sodium Bisulfate is 1.5 g to 6.0 g, and/or the weight of the Adipic Acid is 1.5 g to 6.0 g. The composition may include wherein the composition is dissolved in one gallon of water. The composition may include wherein the buffered solution maintains at least 90% of its initial FAC concentration after 12 months when stored in one of the PET container and/or the HDPE container.

In another aspect, a method of forming a composition includes combining a Calcium Hypochlorite (Ca(OCl)₂), a Sodium Bisulfate (NaHSO₄), and an Adipic Acid (C₆H₁₀O₄), wherein the Calcium Hypochlorite (Ca(OCl)₂) composes 15%-50% by a weight of the composition, wherein the Sodium Bisulfate (NaHSO₄) composes 15%-50% by the weight of the composition, and wherein the Adipic Acid (C₆H₁₀O₄) composes 15%-50% by the weight of the composition. The method may include wherein the Calcium Hypochlorite (Ca(OCl)₂), the Sodium Bisulfate (NaHSO₄), and/or the Adipic Acid (C₆H₁₀O₄) are in powered form. The method may include wherein the weight of the Calcium Hypochlorite is 1.5 g to 6.0 g, the weight of the Sodium Bisulfate is 1.5 g to 6.0 g, and/or the weight of the Adipic Acid is 1.5 g to 6.0 g. The method may include combining the composition with water to form a buffered solution with a pH between 3.5-7. The method may include wherein a FAC concentration in the buffered solution is between 50-1200 ppm.

The method may include wherein the FAC concentration in the buffered solution is between 50-1000 ppm and/or the buffered solution may comprise a pH of 5-7. The method may include wherein the FAC concentration in the buffered solution is between 600-1200 ppm and/or the buffered solution may comprise a pH of 4-5. The method may include wherein the buffered solution maintains at least 90% of its initial FAC concentration after 12 months when stored in a sealed one of the HDPE and/or the PET container, across a FAC range of 50-1200 ppm.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a graphical representation of the chemical components of a composition comprising a calcium hypochlorite, a sodium bisulfate, and/or an adipic acid, according to one embodiment.

FIG. 2 is a diagram showing the steps of adding the composition of FIG. 1 to water to form a buffered solution, according to one embodiment.

FIG. 3 is a process flow diagram describing a method of forming the composition of FIGS. 1-2, according to one embodiment.

### DETAILED DESCRIPTION

Chlorine based disinfectants and methods of preparation of the same are described, and more particularly to a composition that may be mixed with water to form the chlorine based disinfectant, and its associated methods of preparation.

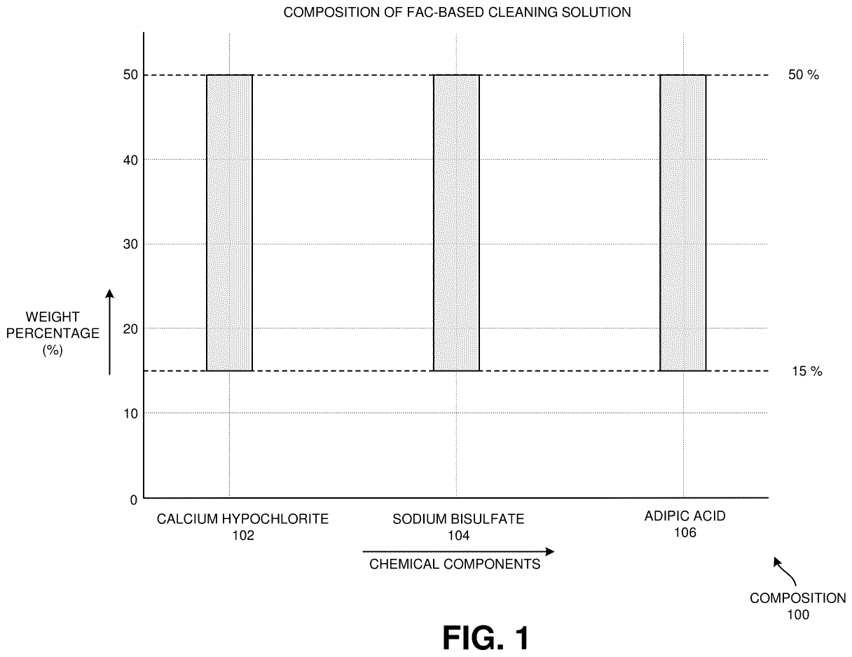

FIG. 1 is a graphical representation of the chemical components of a composition 100 comprising a calcium hypochlorite 102, a sodium bisulfate 104, and/or an adipic acid 106, according to one embodiment.

The composition 100 may be a chemically optimized disinfectant formulation comprising calcium hypochlorite 102, sodium bisulfate 104, and/or adipic acid 106. The composition 100 may generate hypochlorous acid (HOCl) upon dissolution in water 204 (e.g., purified water, partially purified water, distilled water, ultra-filtration water, deionized water, and/or reverse osmosis water), which may provide broad-spectrum antimicrobial efficacy through oxidation and/or pH control. The composition 100 may maintain a free available chlorine (“FAC”) concentration ranging from approximately 50 to 1200 ppm, with an oxidation-reduction potential (“ORP”) of 500 to 1200 mV, ensuring effective microbial inactivation, according to one embodiment. The oxidation-reduction potential, which can be measured in volts or millivolts, may increase with both hydrogen ion concentration (lower pH) and/or the presence of hypochlorous acid (HOCl), which may enhance antimicrobial efficacy.

The composition 100 may exhibit stability in dry and/or solution forms, with a shelf life of at least two years in sealed, high-density polyethylene (“HDPE”) and/or polyethylene terephthalate (“PET”) containers in its powder form and/or up to 12 months when dissolved in the water 204, according to one embodiment. The composition 100, when mixed with the water 204, may maintain an optimal pH range of 3.5-7, which may be facilitated by the interaction of the sodium bisulfate 104 and/or the adipic acid 106, which may stabilize the hypochlorous acid concentration and/or prevent rapid chlorine degradation, according to one embodiment. The composition 100 may be formulated for easy transportation and/or storage as a dry powder shot and/or tablet, allowing for on-demand mixing to generate a stable disinfectant solution.

The composition 100 may be utilized in various settings and/or industries, including but not limited to surface sterilization, water treatment, agriculture, wound care, and/or medical sterilization. The composition 100 may be used to formulate a hand sanitizer and/or skin sanitization solution by dissolving the composition 100 in a suitable medium that may allow for effective skin application while preserving antimicrobial action. The composition 100 may be combined with an aqueous, gel, and/or foam-based carrier to create a formulation suitable for hand sanitization. The composition 100 may be mixed with distilled and/or purified water to generate a liquid hand/skin sanitizer that may provide antimicrobial efficacy while maintaining a skin-compatible pH range of approximately 5-7. The composition 100 may also be combined with thickening agents, which may include but are not limited to carbomer, hydroxyethyl cellulose, and/or xanthan gum, to produce a gel-based sanitizer that may improve adherence and/or prolong contact time on the skin. The composition 100 may be formulated into a foam-based medium by incorporating surfactants, which may include but are not limited to amphoteric and/or nonionic surfactants, to facilitate controlled application and coverage. The composition 100 may maintain the FAC concentration of approximately 500-1000 ppm in hand sanitization formulations, ensuring effective microbial reduction while remaining non-irritating to the skin, according to one embodiment. According to one embodiment.

The composition 100 may be used in wound care applications by dissolving the composition 100 in sterile distilled and/or ultra-filtration water to create a wound irrigation solution that may provide antimicrobial action while maintaining a pH range of approximately 5-7. The composition 100 may be applied to wounds, burns, and/or post-surgical sites to remove debris, reduce bacterial contamination, and/or promote healing, according to one embodiment. For wound care, the composition 100 may comprise an FAC concentration of approximately 50-600 ppm, which may effectively eliminate microbial pathogens without cytotoxic effects on tissue.

The composition 100 may be used in agricultural applications by dissolving the composition 100 in a suitable carrier medium to create an antimicrobial treatment for crops, irrigation systems, and/or livestock sanitation. For agricultural settings, the composition 100 may be prepared in concentrations ranging from approximately 50-200 ppm and/or a pH of 5-7, according to one embodiment. The composition 100 may be applied as a crop treatment by spraying the solution on plant surfaces, where it may reduce bacterial and/or fungal contamination while minimizing residue accumulation. The composition 100 may be incorporated into irrigation systems to prevent microbial buildup in water lines, ensuring pathogen-free water delivery to crops. The composition 100 may also be used in livestock sanitation applications, where the solution may be applied to pens, stalls, and/or drinking water sources to reduce microbial contamination and/or promote hygiene, according to one embodiment. The composition 100 may be packaged in water-soluble sachets and/or pre-measured tablets for controlled dilution in large-scale agricultural settings.

The composition 100 may be used in food processing applications by dissolving the composition 100 in a suitable medium to create an antimicrobial solution for food-contact surfaces, equipment, and/or produce treatment. For food processing, the composition 100 may comprise an FAC concentration of approximately 50-200 ppm and a pH of 5-7. The composition 100 may be applied to food-contact surfaces and/or processing equipment, where it may eliminate microbial contamination without leaving harmful residues. The composition 100 may be used in produce and/or vegetable washing applications, where it may reduce microbial load on fruits, vegetables, and/or meats while maintaining food safety.

The composition 100 may be used in medical sterilization applications by dissolving the composition 100 in a suitable carrier medium, which may include but is not limited to distilled water, purified water, ultra-filtration water, deionized water, and/or reverse osmosis water, to generate a disinfectant solution for medical instruments, surfaces, and/or equipment. The composition 100 may maintain the FAC concentration ranging from approximately 50-1200 ppm and a pH of approximately 3.5-7, depending on application requirements. The composition 100 may be used in high-level disinfection procedures, where the pH and ORP of a buffered solution 206 may ensure effective microbial inactivation, including but not limited to bacterial spores, fungi, viruses, and/or biofilms. The composition 100 may be formulated to prevent pH drift, ensuring that the available chlorine remains in HOCl form, which may provide the highest antimicrobial activity.

The composition 100 may be used in the sterilization of surgical and/or medical instruments/equipment, where the buffered solution 206 may achieve rapid and/or broad-spectrum disinfection while minimizing material degradation. The composition 100 may provide oxidative antimicrobial action through a combination of hypochlorous acid and/or oxidation-reduction potential control, preventing biofilm formation. The buffered solution 206, generated from the composition 100, may be compatible with stainless steel and/or polymer-based medical devices when stored and/or applied within recommended pH and/or concentration parameters. The composition 100 may be used for medical surface disinfection in environments including but not limited to hospitals, surgical centers, clinics, and/or laboratories, where it may provide effective disinfection of high-contact surfaces while maintaining chemical stability over extended exposure periods.

The calcium hypochlorite 102 may be a chemical compound with the formula Ca(OCl)₂, which may provide FAC to the buffered solution 206 when dissolved in the water 204. The calcium hypochlorite 102 may function as the primary oxidizing agent in the composition 100, generating HOCl, which may serve as an active disinfectant, according to one embodiment. The calcium hypochlorite 102 may maintain the FAC concentration in a buffered solution 206 of approximately 50 to 1200 ppm, depending on dilution, and may contribute to the ORP of the solution, which may enhance antimicrobial efficacy, according to one embodiment. The calcium hypochlorite 102 may exhibit stability in dry form for at least two years when stored in a sealed high-density polyethylene and/or polyethylene terephthalate container. The calcium hypochlorite 102 may interact with the sodium bisulfate 104 to maintain a pH range of approximately 3.5-7, which may favor HOCl formation over hypochlorite ions (OCl⁻).

The sodium bisulfate 104 may be a chemical compound with the formula NaHSO₄, which may function as a pH adjuster in the composition 100, according to one embodiment. The sodium bisulfate 104 may regulate the acidity of the solution, ensuring that the calcium hypochlorite 102 generates hypochlorous acid rather than hypochlorite ions, according to one embodiment. The sodium bisulfate 104 may maintain the solution's pH which may optimize HOCl stability and/or prevent rapid chlorine degradation. The sodium bisulfate 104 may also exhibit independent antimicrobial properties by disrupting microbial metabolic processes, interfering with bacterial biofilms, and/or contributing to enzyme inactivation, according to one embodiment. The sodium bisulfate 104 may be used in equal proportion to the calcium hypochlorite 102 and/or the adipic acid 106 in the composition 100, according to one embodiment. The sodium bisulfate 104 may prevent ORP fluctuations and/or preserve the oxidizing efficacy of the solution over an extended storage period.

The adipic acid 106 may be a chemical compound with the formula C₆H₁₀O₄, which may function as a buffering agent in the composition 100, according to one embodiment. The adipic acid 106 may stabilize the pH of the solution, working in conjunction with the sodium bisulfate 104 to prevent fluctuations that may reduce the efficacy of hypochlorous acid, according to one embodiment. The adipic acid 106 may minimize pH drift, ensuring that the calcium hypochlorite 102 remains in an optimal environment for chlorine release, according to one embodiment. The adipic acid 106 may also enhance the long-term stability of the solution, reducing the rate of chlorine degradation over time, according to one embodiment. The adipic acid 106 may be formulated in equal proportion to the calcium hypochlorite 102 and/or the sodium bisulfate 104, according to one embodiment.

According to one embodiment, FIG. 1 discloses a bar graph disclosing the chemical components of the composition 100. As shown in FIG. 1, the calcium hypochlorite 102 may compose 15%-50% of the composition 100 by weight. The sodium bisulfate 104 may compose 15%-50% of the composition 100 by weight. The adipic acid 106 may compose 15%-50% of the composition 100 by weight.

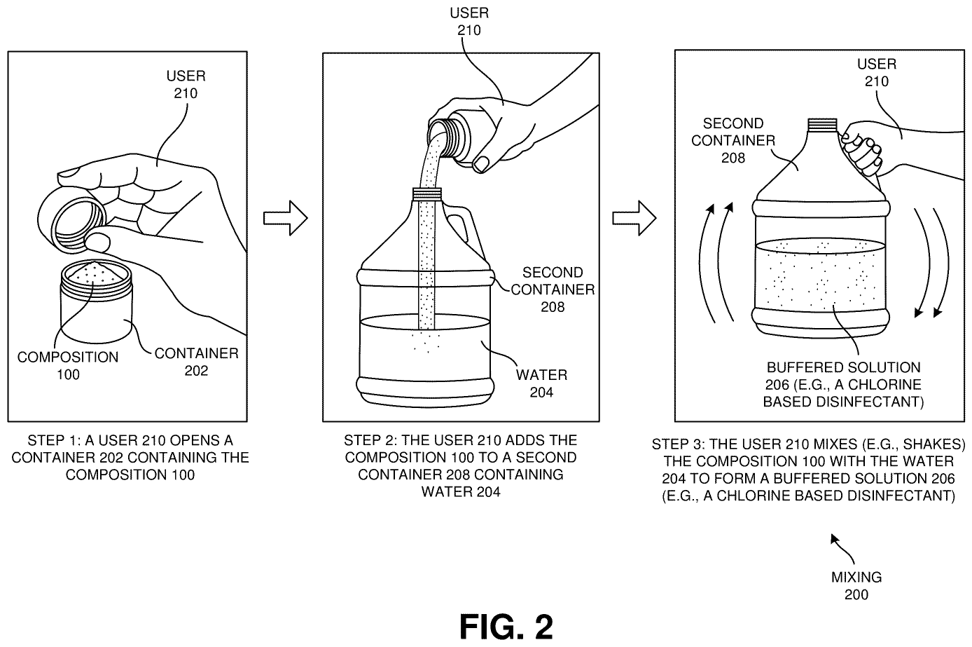

FIG. 2 is a diagram showing the steps of adding the composition 100 of FIG. 1 to water 204 to form a buffered solution 206, according to one embodiment. FIG. 2 discloses the composition 100, a container 202, a water 204, a buffered solution 206, a second container 208, and a user 210, according to one embodiment.

The container 202 may be a vessel that may store and/or dispense the composition 100 in a dry form. The container 202 may be composed of a material that may include but is not limited to high-density polyethylene and/or polyethylene terephthalate, which may provide resistance to oxidation and/or moisture infiltration. The container 202 may include a closure mechanism that may facilitate controlled dispensing of the composition 100, which may include but is not limited to a peel-off top, a twist-off cap, and/or a puncturable seal. The container 202 may maintain an airtight environment to preserve the stability of the composition 100 and/or may be configured for single-use and/or resealable applications.

The water 204 may be a liquid medium that may dissolve the composition 100 to generate the buffered solution 206. The water 204 may include but is not limited to distilled water, purified water, ultra-filtration water, deionized water, and/or reverse osmosis water, which may reduce impurities that may alter the stability and efficacy of the composition 100. The water 204 may facilitate the dissolution of the calcium hypochlorite 102, the sodium bisulfate 104, and/or the adipic acid 106.

The buffered solution 206 may be a chlorine-based disinfectant generated by dissolving the composition 100 in water 204, which may result in a controlled chemical reaction that stabilizes the pH and/or optimizes the formation of hypochlorous acid. The buffered solution 206 may maintain a free available chlorine concentration that may range from approximately 50 to 1200 ppm, with a pH range of approximately 3.5-7, depending on the dilution ratio and/or intended application. The buffered solution 206 may exhibit an oxidation-reduction potential of approximately 500 to 1200 mV, which may contribute to effective microbial inactivation by disrupting cellular structures and/or metabolic processes of bacteria, viruses, and/or fungi, according to one embodiment.

The buffered solution 206 may be formed through a reaction between the calcium hypochlorite 102, the sodium bisulfate 104, and/or the adipic acid 106 when dissolved in the water 204. The calcium hypochlorite 102 may provide the chlorine source, which may rapidly dissociate in the water 204 to release hypochlorite ions (OCl⁻). The sodium bisulfate 104 may lower the pH by introducing hydrogen ions (H⁺), which may shift the equilibrium of chlorine species toward the formation of HOCl, according to one embodiment. The adipic acid 106 may act as a buffering agent, which may resist drastic pH fluctuations by moderating the release of hydrogen ions, ensuring that the buffered solution 206 remains within an optimal pH window for HOCl stability.

The buffered solution 206 may exhibit a predictable pH shift in response to dilution, according to one embodiment. When the buffered solution 206 is prepared at a higher concentration, the solution may stabilize at a pH of approximately 3.5-4.5, which may ensure a higher proportion of HOCl relative to hypochlorite ions, according to one embodiment. As the buffered solution 206 is diluted with the additional water 204, the pH may gradually increase toward approximately 4.5-7, where HOCl may still remain the dominant chlorine species but with a reduced oxidation-reduction potential, according to one embodiment. If further diluted beyond this range, the pH may continue to rise, leading to a shift in equilibrium where hypochlorite ions (OCl⁻) become more prevalent, reducing the overall antimicrobial efficacy of the buffered solution 206, according to one embodiment. The sodium bisulfate 104 and/or the adipic acid 106 may counteract this shift by maintaining sufficient buffering capacity to resist rapid pH drift, ensuring prolonged stability of HOCl in solution, according to one embodiment.

The buffered solution 206 may demonstrate enhanced stability compared to traditional chlorine-based disinfectants due to its ability to maintain pH control over extended periods, according to one embodiment. The interaction of the sodium bisulfate 104 and/or the adipic acid 106 may prevent the degradation of hypochlorous acid into less effective species, reducing the loss of the FAC concentration due to chlorine volatilization. The buffered solution 206 may resist pH drift that may occur in unbuffered chlorine solutions, which may typically degrade due to exposure to air, organic matter, and/or environmental factors. The buffering system within the buffered solution 206 may ensure that the antimicrobial efficacy remains consistent, reducing the need for frequent reapplication and/or pH adjustments in various disinfection and/or sterilization applications, according to one embodiment.

The buffered solution 206 may be formulated for multiple applications by adjusting its dilution. At higher concentrations, the buffered solution 206 may be suitable for high-level disinfection and/or sterilization, where the ORP and/or FAC concentration are maximized for microbial inactivation, according to one embodiment. At lower concentrations, the buffered solution 206 may be adapted for applications requiring prolonged exposure and/or skin contact, such as hand sanitization and/or wound care, where pH stability may be necessary to prevent irritation, according to one embodiment. The buffered solution 206 may maintain its efficacy for up to 12 months when stored in sealed PET and/or HDPE containers, which may prevent degradation due to light exposure and/or gas exchange.

The second container 208 may be a vessel that may receive and/or store the buffered solution 206. The second container 208 may be used for storage, application, and/or transport of the buffered solution 206. The second container 208 may be composed of HDPE and/or PET to prevent chemical degradation and/or chlorine gas loss, according to one embodiment. The second container 208 may be configured for sealed storage to maintain the stability of the buffered solution 206 for an extended period, which may be up to 12 months when stored in controlled conditions. The second container 208 may be adapted for various dispensing methods, including but not limited to spray nozzles, pump mechanisms, and/or direct pour applications.

The user 210 may be a person who may mix the composition 100 with the water 204 to create the buffered solution 206. The user 210 may be an individual in various fields, including but not limited to healthcare, agriculture, military, and/or sanitation, where the buffered solution 206 may be used for disinfection and/or sterilization.

According to one embodiment, FIG. 2 discloses a mixing process 200. The mixing process 200 may involve multiple steps in which the composition 100 is introduced into the water 204 to generate the buffered solution 206. Step “1” may include the user 210 opening the container 202, which may contain the composition 100 in a dry form. The container 202 may be sealed with a peel-off top, a twist-off cap, and/or a puncturable seal, which may be removed to dispense the composition 100. Step “2” may include the user 210 pouring the composition 100 from the container 202 into a volume of the water 204, which may be contained within the second container 208, according to one embodiment. Step “3” may include the user 210 mixing the composition 100 with the water 204 to initiate dissolution and/or chemical activation, which may be performed by shaking, stirring, and/or another agitation method.

As the composition 100 dissolves in the water 204, the buffered solution 206 may be formed, wherein the calcium hypochlorite 102 may release hypochlorite ions, the sodium bisulfate 104 may introduce hydrogen ions to adjust pH, and the adipic acid 106 may provide buffering action to stabilize the solution. The mixing process 200 may ensure complete dissolution of the composition 100, generating a chlorine-based disinfectant with a controlled pH range and/or the free available chlorine concentration. The FAC concentration and pH of the buffered solution 206 may be dependent on the ratio of the composition 100 to the volume of the water 204. Adding more of the composition 100 may decrease the pH of the buffered solution 206 due to the increased concentration of the sodium bisulfate 104 and/or the adipic acid 106, which may introduce additional hydrogen ions. The decrease in pH may enhance the conversion of hypochlorite ions (OCl⁻) into hypochlorous acid (HOCl), which may increase the antimicrobial efficacy of the buffered solution 206. Conversely, reducing the amount of the composition 100 or increasing the volume of the water 204 may increase the pH, shifting the equilibrium toward hypochlorite ions, which may reduce overall antimicrobial activity, according to one embodiment. The FAC concentration may scale proportionally with the amount of the composition 100 added to the water 204, with higher concentrations producing a stronger disinfectant solution and lower concentrations producing a milder formulation suitable for applications, including but not limited to hand sanitization and/or wound care, according to one embodiment.

The second container 208 may be used to store the buffered solution 206, and it may be sealed to prevent chlorine gas loss and/or contamination. The buffered solution 206 may be used immediately after mixing or stored in PET and/or HDPE containers to maintain stability for an extended period.

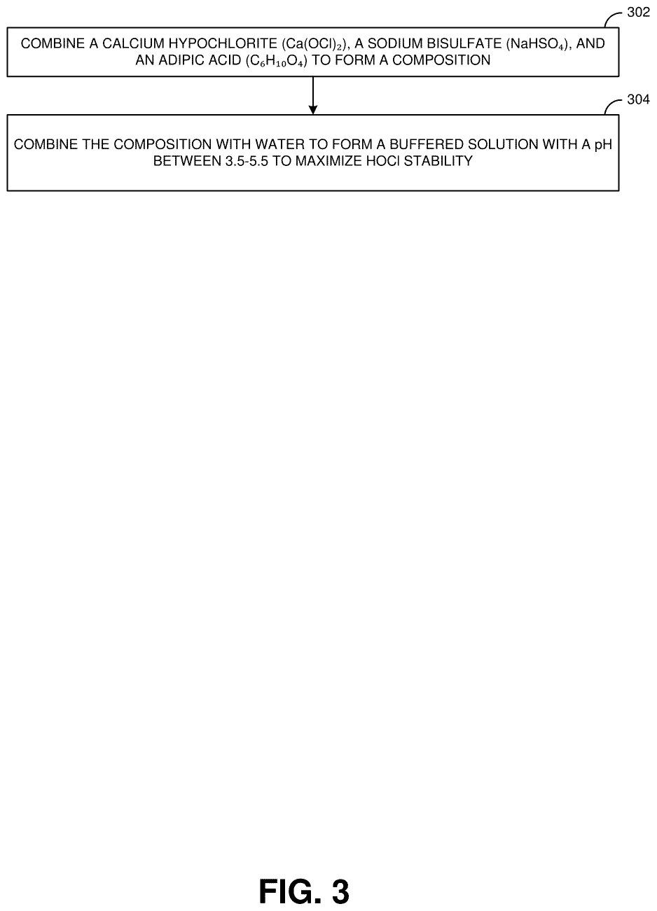

FIG. 3 is a process flow diagram describing a method of forming the composition 100 of FIGS. 1-2, according to one embodiment. In operation 302, a calcium hypochlorite (Ca(OCl)₂) 102, a sodium bisulfate (NaHSO₄) 104, and an adipic acid (C₆H₁₀O₄) 106 may be combined to form a composition 100. In operation 304, the composition 100 may be combined with water 204 to form a buffered solution 206 with a pH between 3.5-5.5 to maximize HOCl stability.

The following is a plain-English example of the Chlorine-Based Disinfectant:

Jill is a hospital employee tasked with cleaning and/or disinfecting various instruments and equipment throughout the hospital, according to one embodiment. To conduct this cleaning/disinfecting, Jill uses a chlorine-based disinfectant called MicroShotz™, according to one embodiment. MicroShotz™ is a dry, powdered composition 100 comprising calcium hypochlorite 102, sodium bisulfate 104, and/or adipic acid 106, according to one embodiment. The composition 100 may be stored in a PET and/or an HDPE container, which may provide resistance to oxidation and/or moisture infiltration, ensuring long-term stability of the composition 100, according to one embodiment. The container 202 may include a peel-off top, a twist-off cap, and/or a puncturable seal, which may facilitate controlled dispensing of the composition 100, according to one embodiment. The dry formulation of the composition 100 may allow for convenient storage and/or transport without requiring the shipment of heavy liquid disinfectants, according to one embodiment.

Jill retrieves a pre-measured MicroShotz™ disinfectant packet from hospital storage, according to one embodiment. Each packet may contain a precise weight percentage of 15%-50% of the calcium hypochlorite 102, 15%-50% of the sodium bisulfate 104, and/or 15%-50% of the adipic acid 106, according to one embodiment. The formulation may ensure that, when dissolved, a buffered solution 206 may maintain a free available chlorine concentration of approximately 50-1200 ppm with an oxidation-reduction potential of approximately 500-1200 mV, ensuring strong antimicrobial efficacy, according to one embodiment.

To prepare the buffered solution 206, Jill opens the packet and pours the composition 100 into one gallon of the water 204, according to one embodiment. The water 204 may include but is not limited to distilled water, purified water, ultra-filtration water, deionized water, and/or reverse osmosis water, according to one embodiment. The composition 100 may be mixed with the water 204 contained within a sterile, sealed HDPE container, according to one embodiment. Jill then mixes the solution for approximately 30-60 seconds to ensure full dissolution, according to one embodiment. As the composition 100 dissolves, the calcium hypochlorite 102 may release hypochlorite ions (OCl⁻), the sodium bisulfate 104 may introduce hydrogen ions (H⁺) to lower the pH, and/or the adipic acid 106 may stabilize the solution, preventing pH drift, according to one embodiment. The buffered solution 206 may reach an optimal pH of approximately 3.5-7, ensuring that hypochlorous acid (HOCl) remains the dominant chlorine species, maximizing its disinfecting power, according to one embodiment.

Once fully mixed, Jill transfers the buffered solution 206 into a spray bottle and/or an automated disinfectant dispensing system, according to one embodiment. The buffered solution 206 may maintain stability for up to 12 months when stored in a sealed PET and/or HDPE container, preventing chlorine gas loss and/or degradation, according to one embodiment. Jill applies the buffered solution 206 to high-touch hospital surfaces, surgical instruments, and/or medical equipment, according to one embodiment. For non-porous surfaces, she may allow the buffered solution 206 to sit for one to five minutes, ensuring that the hypochlorous acid effectively inactivates bacteria, viruses, and/or biofilms, according to one embodiment. The pH-stabilized formulation may prevent corrosion of stainless steel medical instruments, making it suitable for use on sensitive equipment, according to one embodiment.

After completing the disinfection process, Jill stores the remaining buffered solution 206 in a sealed PET and/or HDPE container, where it may remain stable and effective for up to 12 months, according to one embodiment. This may allow the hospital to prepare the buffered solution 206 on-demand while ensuring a continuous supply of disinfectant is readily available for future use, according to one embodiment.

The dry powder formulation of the composition 100 may provide significant advantages over traditional liquid disinfectants in a hospital setting, according to one embodiment. Because it may be stored and shipped in dry form, it may eliminate the need for transporting heavy liquid disinfectants, reducing shipping costs and/or storage requirements, according to one embodiment. The on-demand mixing process may allow users to prepare the buffered solution 206 as needed, ensuring maximum potency and/or effectiveness without concerns about degradation or expiration, according to one embodiment. The extended shelf life of the composition 100, which may exceed two years in sealed storage, may allow users to stockpile disinfectant without waste, providing a cost-effective and/or reliable solution for infection control, according to one embodiment. The ability to quickly and efficiently prepare a hospital-grade disinfectant may make the composition 100 an ideal solution for medical facilities requiring consistent and effective sterilization protocols, according to one embodiment.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A composition comprising:
15%-50% by a weight of a Calcium Hypochlorite (Ca(OCl)₂);
15%-50% by the weight of a Sodium Bisulfate (NaHSO₄); and
15%-50% by the weight of an Adipic Acid (C₆H₁₀O₄).

2. The composition of claim 1, wherein each of the Calcium Hypochlorite, the Sodium Bisulfate, and the Adipic Acid are in powder form.

3. The composition of claim 1, wherein the composition is packaged in at least one of an HDPE container and a PET container.

4. The composition of claim 1, wherein the composition is dissolved in a water to form a buffered solution that maintains a pH of 3.5-7.

5. The composition of claim 1, wherein a FAC concentration in the buffered solution is between 50-1200 ppm.

6. The composition of claim 4, wherein the FAC concentration in the buffered solution is between 500-1000 ppm and the buffered solution comprises a pH of 5-7.

7. The composition of claim 4, wherein the FAC concentration in the buffered solution is between 50-200 ppm and the buffered solution comprises a pH of 5-7.

8. The composition of claim 4, wherein the buffered solution is stored in the HDPE container.

9. The composition of claim 4, wherein the buffered solution is stored in the PET container.

10. The composition of claim 1 wherein:
the weight of the Calcium Hypochlorite is 1.5 g to 6.0 g;
the weight of the Sodium Bisulfate is 1.5 g to 6.0 g; and
the weight of the Adipic Acid is 1.5 g to 6.0 g.

11. The composition of claim 10, wherein the composition is dissolved in one gallon of water.

12. The composition of claim 10, wherein the buffered solution maintains at least 90% of its initial FAC concentration after 12 months when stored in one of the PET container and the HDPE container.

13. A method of forming a composition comprising:
combining a Calcium Hypochlorite (Ca(OCl)₂), a Sodium Bisulfate (NaHSO₄), and an Adipic Acid (C₆H₁₀O₄),
wherein the Calcium Hypochlorite (Ca(OCl)₂) composes 15%-50% by a weight of the composition,
wherein the Sodium Bisulfate (NaHSO₄) composes 15%-50% by the weight of the composition, and
wherein the Adipic Acid (C₆H₁₀O₄) composes 15%-50% by the weight of the composition.

14. The method of claim 13 wherein the Calcium Hypochlorite (Ca(OCl)₂), the Sodium Bisulfate (NaHSO₄), and the Adipic Acid (C₆H₁₀O₄) are all in powered form.

15. The method of claim 13 wherein:
the weight of the Calcium Hypochlorite is 1.5 g to 6.0 g;
the weight of the Sodium Bisulfate is 1.5 g to 6.0 g; and
the weight of the Adipic Acid is 1.5 g to 6.0 g.

16. The method of claim 13 further comprising combining the composition with water to form a buffered solution with a pH between 3.5-5.5 to maximize HOCl stability.

17. The method of claim 16, wherein a FAC concentration in the buffered solution is between 50-1200 ppm.

18. The method of claim 16, wherein the FAC concentration in the buffered solution is between 50-1000 ppm and the buffered solution comprises a pH of 5-7.

19. The method of claim 16, wherein the FAC concentration in the buffered solution is between 600-1200 ppm and the buffered solution comprises a pH of 4-5.

20. The method of claim 16, wherein the buffered solution maintains at least 90% of its initial FAC concentration after 12 months when stored in a sealed one of the HDPE and the PET container, across a FAC range of 50-1200 ppm.
